(19) United States
(12) Patent Application Publication
(10) Pub. No.: US 2011/0113148 A1
(43) Pub. Date: May 12, 2011

(54) METHOD AND APPARATUS FOR PROVIDING A MEETING POINT AND ROUTES FOR PARTICIPANTS TO A PROPOSED MEETING

(75) Inventors: Mika Salmela, Oulu (FI); Aki Happonen, Kiiminki (FI); Jarmo Antero Nikula, Jaali (FI); Jyrki Leskela, Haukipudas (FI)

(73) Assignee: Nokia Corporation, Espoo (FI)

(21) Appl. No.: 12/614,757

(22) Filed: Nov. 9, 2009

(51) Int. Cl. G06F 15/16

(52) U.S. Cl. 709/229

(57) ABSTRACT

A method including causing determination of locations of participants to a proposed meeting. The method further includes determining a meeting point and proposed routes of the participants to the meeting point based on the locations of the participants; and electronically providing, to the participants, the meeting point and the proposed routes for display.

### BACKGROUND

Service providers and device manufacturers are continually challenged to deliver value and convenience to consumers by, for example, providing compelling network services. Mapping applications can provide a user with a proposed route from a first location to a second location. Additionally, certain applications allow a user to share a current location of the user with other individuals, and vice versa. However, if the user want to meet with one or more of the individuals, such mapping applications do not provide the user with the ability to easily select a meeting point for the user and the individual(s).

### Some Example Embodiments

Therefore, there is a need for an approach for providing a meeting point and routes for participants to a proposed meeting.

According to one embodiment, a method comprises causing determination of locations of participants to a proposed meeting, determining a meeting point and proposed routes of the participants to the meeting point based on the locations of the participants, and electronically providing, to the participants, the meeting point and the proposed routes for display.

According to another embodiment, an apparatus comprising at least one processor, and at least one memory including computer program code, the at least one memory and the computer program code configured to, with the at least one processor, cause, at least in part, the apparatus to perform at least the following: cause determination of locations of participants to a proposed meeting; determine a meeting point and proposed routes of the participants to the meeting point based on the locations of the participants; and electronically provide, to the participants, the meeting point and the proposed routes for display.

According to another embodiment, a computer-readable storage medium carrying one or more sequences of one or more instructions which, when executed by one or more processors, cause, at least in part, an apparatus to at least perform the following steps: causing determination of locations of participants to a proposed meeting; determining a meeting point and proposed routes of the participants to the meeting point based on the locations of the participants; and electronically providing, to the participants, the meeting point and the proposed routes for display.

According to another embodiment, an apparatus comprises means for causing determination of locations of participants to a proposed meeting, means for determining a meeting point and proposed routes of the participants to the meeting point based on the locations of the participants, and means for electronically providing, to the participants, the meeting point and the proposed routes for display.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a meeting point and routes for participants to a proposed meeting, according to one embodiment;

FIG. 2 is a diagram of the components of user equipment capable of providing a meeting point and routes for participants to a proposed meeting, according to one embodiment;

FIG. 3 is a diagram of the components of a service platform capable of providing a meeting point and routes for participants to a proposed meeting, according to one embodiment;

FIG. 4A is a mobile device capable of providing a meeting point and routes for participants to a proposed meeting, according to one embodiment;

FIG. 4B is an enlarged view of a touchscreen user input device of the mobile device shown in FIG. 4A, which is capable of providing a meeting point and routes for participants to a proposed meeting, according to one embodiment;

FIG. 5A is a flowchart of a process for providing a meeting point and routes for participants to a proposed meeting using, for example, the mobile device of FIGS. 2 and 4A, according to one embodiment;

FIG. 5B is a flowchart of a process for providing an adjusted meeting point and routes for participants to a proposed meeting using, for example, the mobile device of FIGS. 2 and 4A, according to one embodiment;

FIG. 5C is a flowchart of a process for providing adjustment of a meeting point and routes for participants to a proposed meeting based on progress of participants along routes to the meeting point using, for example, the mobile device of FIGS. 2 and 4A, according to one embodiment;

FIG. 6A is a flowchart of a process for providing a meeting point and routes for participants to a proposed meeting using, for example, the service platform of FIG. 3, according to one embodiment;

FIG. 6B is a flowchart of a process for providing an adjusted meeting point and routes for participants to a proposed meeting using, for example, the service platform of FIG. 3, according to one embodiment;

FIG. 6C is a flowchart of a process for providing adjustment of a meeting point and routes for participants to a proposed meeting based on progress of participants along routes to the meeting point using, for example, the service platform of FIG. 3, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing a meeting point and routes for participants to a proposed meeting are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

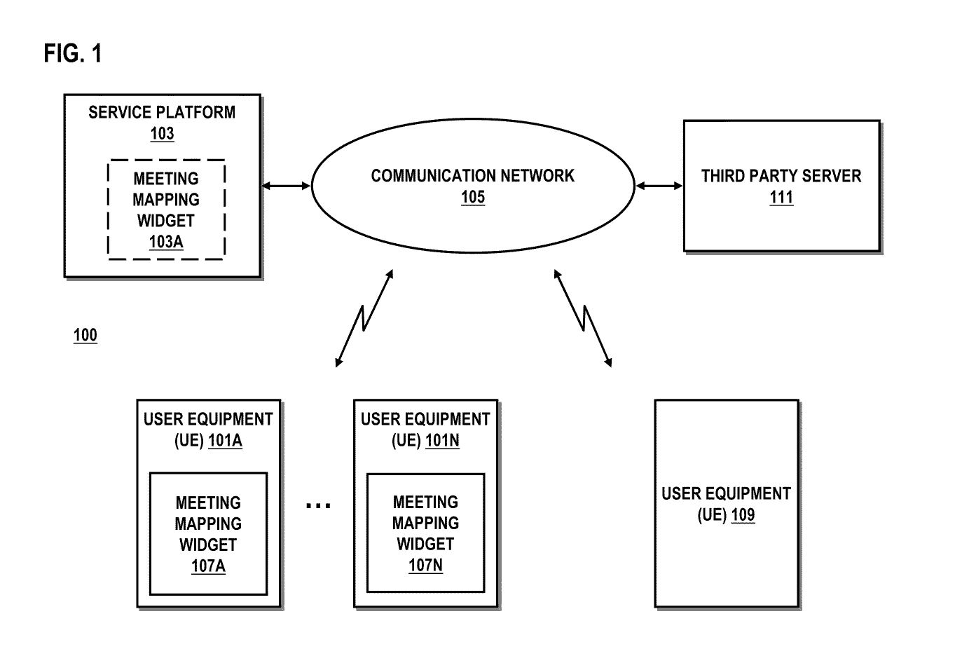

FIG. 1 is a diagram of a system capable of providing a meeting point and routes for participants to a proposed meeting, according to one embodiment. Mapping applications can provide a user with a proposed route from a first location to a second location. Additionally, certain applications allow a user to share a current location of the user with other individuals, and vice versa. However, if the user want to meet with one or more of the individuals, such mapping applications do not provide the user with the ability to easily select a meeting point for the user and the individual(s).

To address this problem, a system 100 of FIG. 1 introduces the capability to provide a meeting point and routes for participants to a proposed meeting. The system 100 provides the user with a map and the locations of the participants on the map, and allows the user to select a meeting point by providing to the user an indication of a travel time for each participant to the meeting point and proposed routes to the meeting point for each participant.

As shown in FIG. 1, the system 100 comprises user equipment (UE) 101A . . . 101N. The UEs 101A . . . 10N have connectivity to each other and to a service platform 103 via a communication network 105. In certain embodiments, the service platform 103 can include a meeting mapping widget 103A, as will be discussed in greater detail below. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UEs 101A . . . 101N are any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), navigation unit (e.g., portable GPS unit), or any combination thereof. It is also contemplated that the UEs 101A . . . 101N can support any type of interface to the user (such as “wearable” circuitry, etc.).

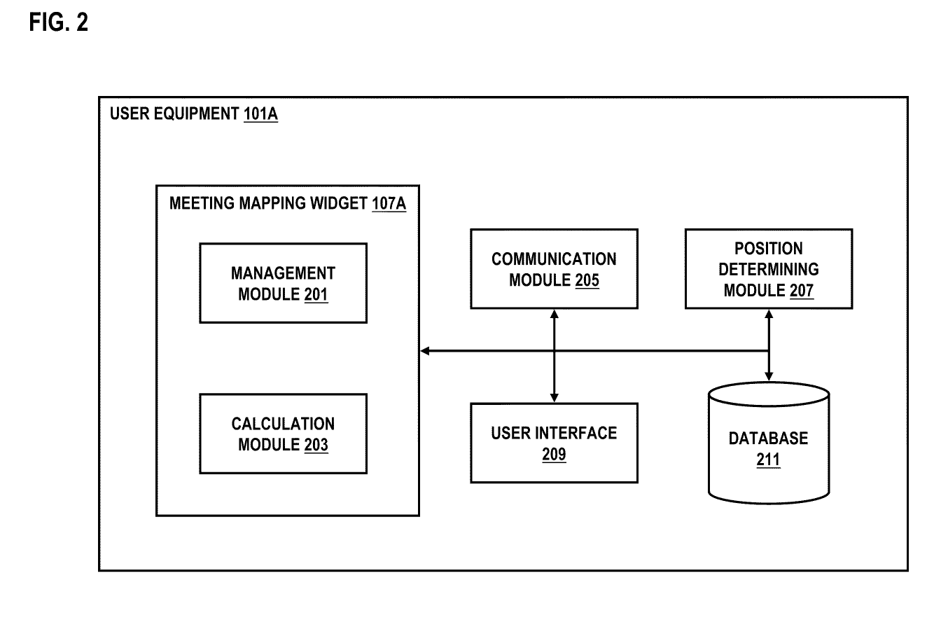

The UEs 101A . . . 10N include a meeting mapping widget 107A . . . 107N, respectively, which will be described in greater detail below with respect to FIG. 2. The meeting mapping widgets 103A and 107A . . . 107N can be a software application that works in conjunction with other application, or can be provided as a component within a mapping application and/or navigation application.

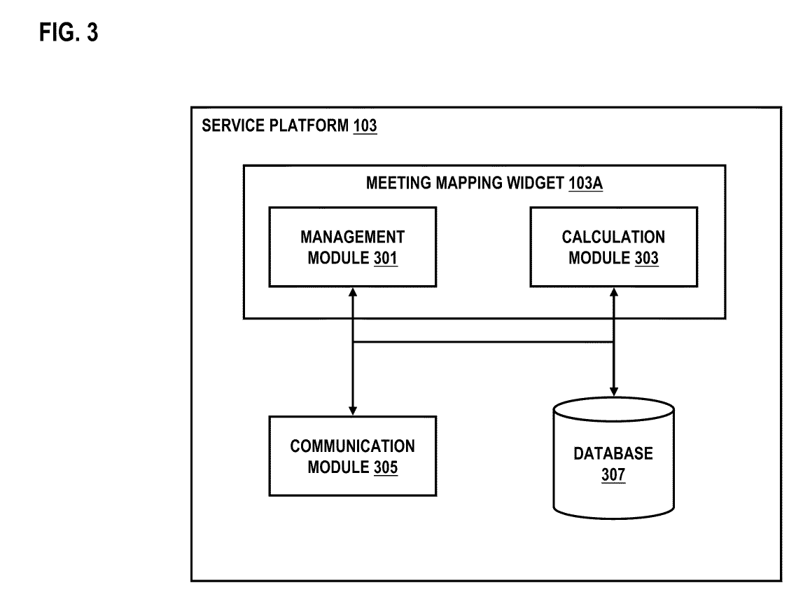

As shown in FIG. 1, the system 100 also comprises UE 109 that has connectivity to the UEs 101A . . . 101N and to the service platform 103 via the communication network 105. The UE 109 does not include a meeting mapping widget, but can be used by a participant in a proposed meeting, as described in greater detail below with respect to FIGS. 2 and 3. Additional, UEs without meeting mapping widgets can be used in the system 100. The UE 109 is configured to allow a location thereof to be determined, either using internal components of the UE 109 (e.g., a position determining modules such as a global positioning system (GPS) transmitter/receiver) and/or using external components (e.g., a cellular system that can approximate a location of the UE 109 based on cellular transmitter usage, etc.).

As shown in FIG. 1, the system 100 also comprises a third party server 111 that has connectivity to the UEs 101A . . . 101N, UE 109, and the service platform 103 via the communication network 105. The third party server 111 can be, for example, a mapping server or other third party server that can be used in conjunction with an application providing a meeting point and routes for participants to a proposed meeting.

By way of example, the UEs 101A . . . 101N, UE 109, service platform 103, and third party server 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

FIG. 2 is a diagram of the components of user equipment 101A capable of providing a meeting point and routes for participants to a proposed meeting, according to one embodiment. By way of example, the user equipment 101A includes one or more components for providing a meeting point and routes for participants to a proposed meeting. It is contemplated that the functions of these components may be combined in one or more components or performed by other components of equivalent functionality. Additionally, these components may be used in conjunction with components separate from the UE 101A, such as components of the service platform 103, components of other UEs, such as UE 101N and/or UE 109, and/or components of the third party server 111, in order to provide the meeting point and routes for participants to the proposed meeting.

In this embodiment, the user equipment 101A includes one or more processors and one or more memory storage devices that provide a meeting mapping functionality. The meeting mapping widget 107A includes a management module 201 and a calculation module 203. The user equipment 101A further includes a communication module 205, a position or location determining module 207, a user interface 209, and a database 211. The communication module 205 is configured to communicate via the communication network 105 with the service platform 103, other UEs, such as UE 101N and UE 109, and the third party server 111. The position determining module 207 can be a GPS receiver/transmitter, or other device that aids in the determination of the location of the user equipment 101A. The user interface 209 can include any variety of features that allow a user to input information into the user equipment and allow the user equipment to output information from the user equipment, for example, to the user. For example, the user interface 209 can include a display, such as a touchscreen display, buttons, a speaker, a microphone, etc. The database 211 can store information relating to the meeting mapping functions of the UE 101A, such as user preferences/settings, etc., and/or information relating to other functions of the UE 101A.

The meeting mapping widget 107A and the components thereof can be provided within the UE, such as in UE 101A shown in FIG. 2, or such components can be incorporated into the service platform, such as service platform 103 shown in FIG. 3. Thus, the functions of the meeting mapping widget can be performed and/or controlled exclusively by the components of the UE, or exclusively by the components of the service platform, or jointly by components of both the UE and the service platform. Whether components of the UE are being utilized or components of the service platform are being utilized for certain tasks can be determined based on factors such as energy usage of the UE, calculation and/or storage capabilities of the UE, data transmission limitations/factors between the UE and the service platform, etc.

In FIG. 2, the meeting mapping widget 107A includes a management module 201 that is configured to control a meeting mapping session and the processes associated with the meeting mapping session, and a calculation module 203 that is configured to perform any calculations needed for the meeting mapping session, such as, for example, the calculation of estimated travel times of the participants, the mapping of proposed routes, and/or the determination of alternative meeting points for display.

FIG. 3 is a diagram of the components of a service platform capable of providing a meeting point and routes for participants to a proposed meeting, according to one embodiment. By way of example, the service platform 103 includes a meeting mapping widget 103A that includes one or more components for providing a meeting point and routes for participants to a proposed meeting. It is contemplated that the functions of these components may be combined in one or more components or performed by other components of equivalent functionality. Additionally, these components may be used in conjunction with components separate from the service platform 103, such as components of the UEs, such as UEs 101A . . . 101N and/or UE 109, and/or components of the third party server 111, in order to provide the meeting point and routes for participants to the proposed meeting.

In this embodiment, the service platform 103 includes one or more processors and one or more memory storage devices that provide a meeting mapping functionality. The meeting mapping widget 103A of the service platform 103 includes a management module 301 and a calculation module 303. The service platform 103 further includes a communication module 305, and a database 307. The communication module 305 is configured to communicate via the communication network 105 with the UEs, such as UEs 101A . . . 101N and UE 109, and the third party server 111. The database 307 can store information relating to the meeting mapping functions of the service platform 103, such as user preferences/settings, etc., and/or information relating to other functions of the service platform, and/or information received from the UEs.

Thus, the meeting mapping functions can be performed and/or controlled exclusively by the components of the service platform 103 in conjunction with the receipt of location information of the UEs, or exclusively by the components of the UEs, or jointly by components of both the UE and the service platform.

In FIG. 3, the meeting mapping widget 103A includes a management module 301 that is configured to control a meeting mapping session and the processes associated with the meeting mapping session, and a calculation module 303 that is configured to perform any calculations needed for the meeting mapping session, such as, for example, the calculation of estimated travel times of the participants, the mapping of proposed routes, and/or the determination of alternative meeting points for display. As noted above, the management module 301 and the calculation module 303 can be used to perform/control the meeting mapping session or can be used in conjunction with a meeting mapping widget on a UE to perform certain functions, while other functions are performed by the widget on the UE.

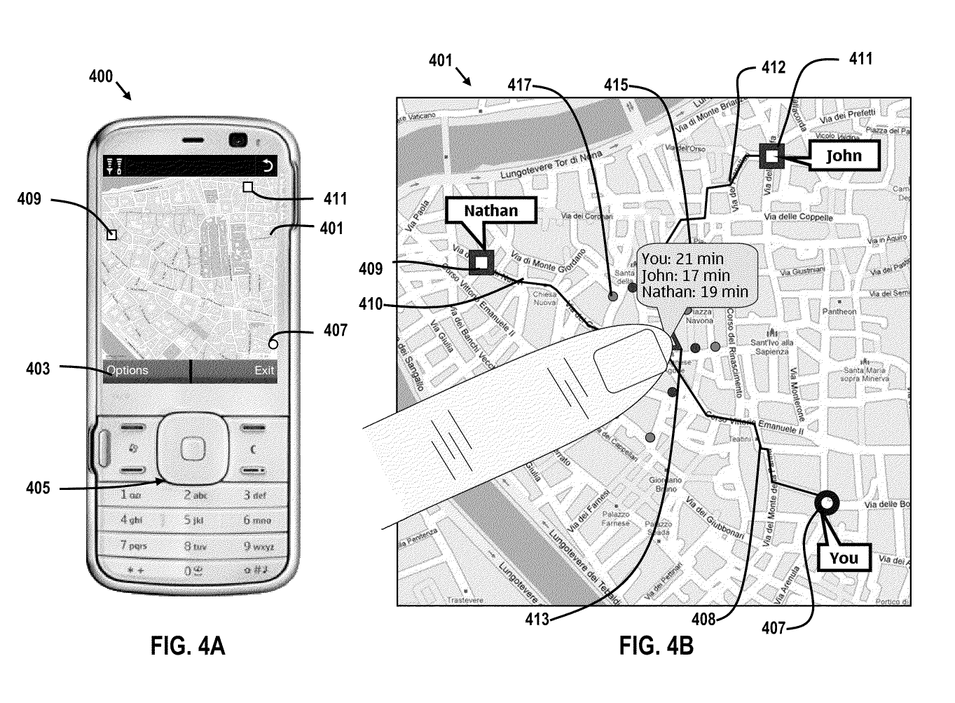

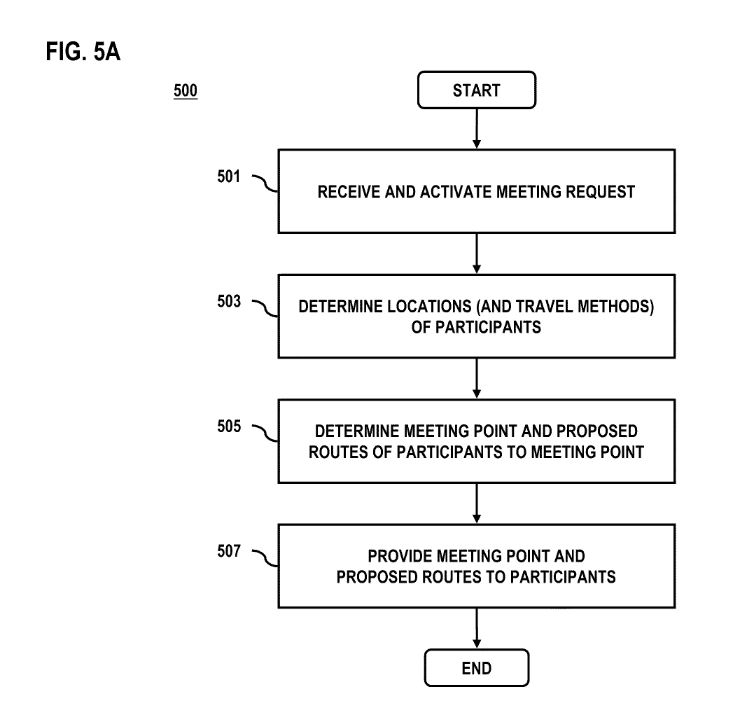

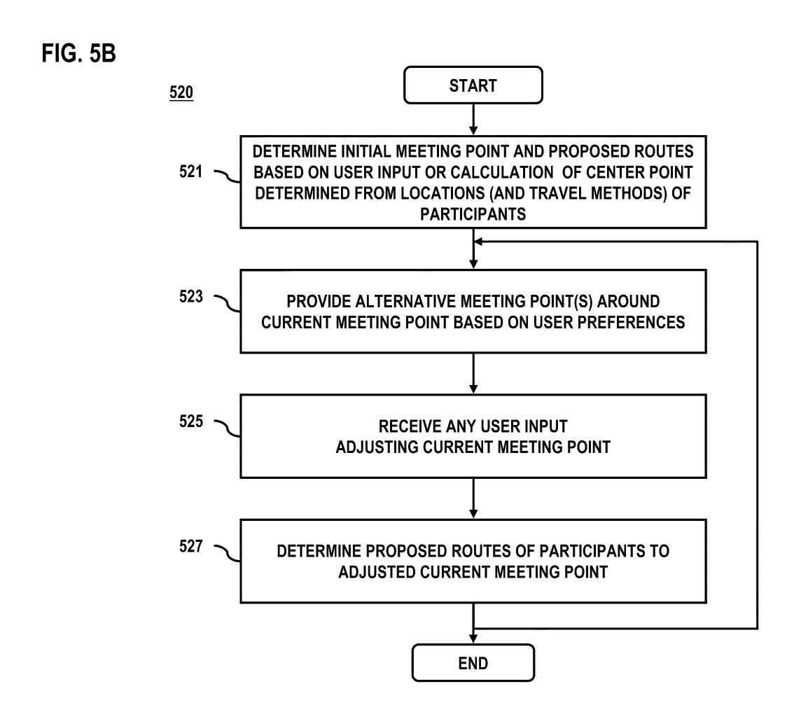

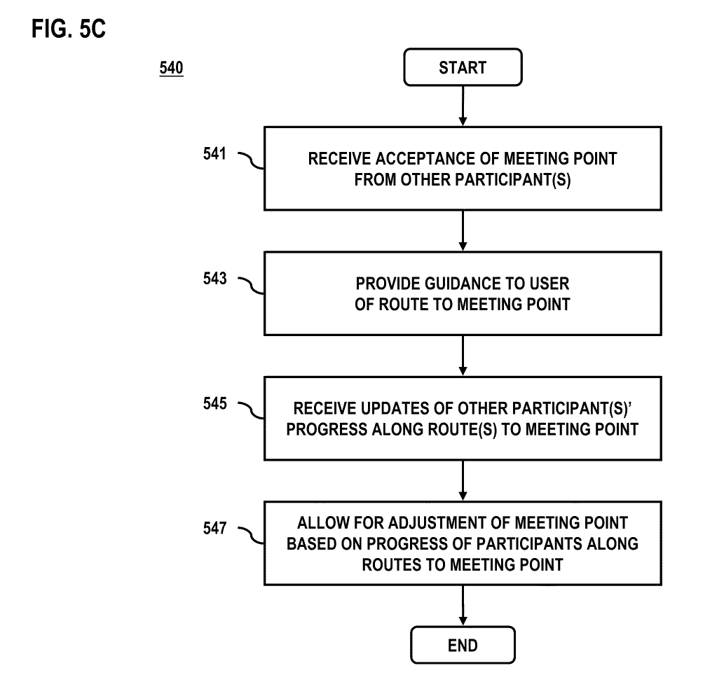

FIG. 4A is a mobile device or user equipment 400 capable of providing a meeting point and routes for participants to a proposed meeting, according to one embodiment. FIG. 4B is an enlarged view of a touchscreen user input device of the mobile device shown in FIG. 4A, which is capable of providing a meeting point and routes for participants to a proposed meeting, according to one embodiment. The mobile device 400 includes user interfaces utilized in the processes of FIGS. 5A-5C, according to various embodiments. The mobile device can be any of the UEs discussed above, and vice versa. For example, the mobile device can be any type of mobile terminal, or portable terminal including a mobile handset, station, unit, device, multimedia computer, multimedia tablet, Internet node, communicator, computer, laptop computer (e.g., with a GPS and SIM card), Personal Digital Assistants (PDAs), navigation unit (e.g., portable GPS unit), or any combination thereof.

The mobile device 400 includes a display screen 401, such as, for example, a touchscreen. The display screen 401 includes display buttons 403 that can be actuated by a user, for example, by touching the display screen 401 and/or by utilizing one or more of the selection buttons 405 provided on the mobile device 400.

In FIG. 4A, upon actuation of a meeting mapping session, the mobile device 400 utilizes a mapping feature, for example, controlled by management module 201 to display a map of the area surrounding a present location of the mobile device 400. Thus, the display screen 401 displays an icon 407 (e.g., a symbol, description, picture, etc.) that represents the mobile device 400 at the present location on the map, an icon 409 that represents a present location of a first participant on the map, and an icon 411 that represents a present location of a second participant on the map. The meeting mapping session can include two or more participants. It is noted that the icon 407 of the mobile device 400 is different and thus distinguished from the icons 409 and 411 of the other participants. The location of icon 407 on the map can be determined by the management module 201 by utilizing a position determining module 207 or by receiving location information via the communication module 205 that indicates the location of the mobile device 400 (e.g., from a remote server that is capable of detecting or determining the location of the mobile device 400). The location of the icons 409 and 411 on the map can be determined by the management module 201 by receiving location information via the communication module 205 from UEs of the other participants or from a remote server capable of detecting or determining the location of the UEs of the other participants. The other participants can provide authorization to the mobile device 400 to utilize the locations of their UEs in general, and/or for particular meeting mapping sessions.

FIG. 4A depicts the map and icons of the participants prior to a depiction of a meeting point, which can be automatically calculated by the meeting mapping widget (e.g., using the calculation module 203) and/or can be selected by the user, for example, user the touchscreen display 401 and/or one or more buttons 405. In the initial display of the map and icons, the meeting mapping widget will cause the display of a map that is scaled to include each of the participants therein, and therefore if the participants are spread out over large distances then the map will be zoomed out and if the participants are close to one another then the map will be zoomed in. If the meeting mapping widget does not calculate the initial meeting point, but rather the user manually selects the proposed meeting point, and if the participants are spread out such that the map is zoomed out, then the meeting mapping widget can allow the user to zoom in to show greater and greater details (e.g., streets, street names, parks, cafes, etc.) so that the map resolution is suitable for manually selecting a proposed meeting point. In this situation, the meeting mapping widget would start from a wide resolution, and then allow the user to zoom into finer scale (e.g., from a country wide view, to a city wide view, etc.).

FIG. 4B shows a user's finger selecting a meeting point represented on the display screen 401 by a meeting point icon 413 (e.g., a symbol, description, picture, etc.). Upon designation of a meeting point, the meeting mapping widget (e.g., using the calculation module 203) maps proposed routes 408, 410, and 412, for the meeting participants 407, 409, and 411, respectively, from their current locations to the meeting point. Additionally, upon designation of the meeting point, the meeting mapping widget (e.g., using the calculation module 203) calculates estimated travel times for each participant from their current location to the meeting point and causes the display of a dialog box 415 that indicates the estimated travel times. The calculation of the estimated travel times can be performed by taking into account the distance between the current location of the participant and the meeting point, the proposed route of the participant from the current location to the meeting point (e.g., factoring in the distances of the roads in the route, speed limits on the roads, traffic signals on the roads, traffic congestion on the roads, etc.), and the travel method of the participant (e.g., walking, running, biking, driving, travelling by train/boat/airplane, etc.) as indicated by the participant during authorization by the participant to join the meeting mapping session and/or preferences set by the participant.

Additionally, in FIG. 4B, the meeting mapping widget 107A (e.g., using the calculation module 203, and possibly also the database 211) causes the display screen 401 to display one or more alternative meeting points, one of which is labeled as icon 417, which are in the vicinity of the current meeting point (e.g., a predetermined radius around the current meeting point, which can be dependent upon the overall scale of the map, for example, within a 1 kilometer radius for an overall map in which the participants are separated by 50 kilometers, or within a 100 meter radius for an overall map in which the participants are separated by 1 kilometer). The alternative meeting points can be provided by the meeting mapping widget based on preset factors determined by the widget manufacturer or distributor, or by preferences set by one or more of the participants in the meeting mapping session (e.g., the participant utilizing mobile device 400, and/or one or more of the other participants). For example, the participant utilizing mobile device 400 can set preferences for the widget to display cafes, parks, museums, restaurants (e.g., serving a particular type of food, based on price, etc.), bars, previous meeting points, etc. in the vicinity of the meeting point. The user could also set a user preference that could include a carbon footprint indication that could be displayed with suggested meeting points on the map, for example, by displaying which suggested meeting point is most eco-friendly. The user could also specify a certain radius around the meeting point to provide such alternative meeting points. Also, the icon 417 of the alternative meeting points could be interactive such that the user can select the icon 417 and a dialog box, new window, or other information could be displayed on the display screen that provides the user with further information regarding the alternative meeting point (e.g., name, description, operating hours, address, phone number, hyperlink to website, etc.).

The user can utilize the touchscreen of the display screen 401 or other buttons of the mobile device 400 to adjust the meeting point 413. Additionally, the meeting mapping widget 107A can dynamically update the estimated travel times of the participants in dialog box 415 as the meeting point is adjusted, and can dynamically update the proposed routes of the participants to the meeting point based on the adjustment of the meeting point and/or the manual adjustment of the proposed route by the user.

Once the user decides on a final meeting point, the meeting mapping widget 107A can cause the transmission of the proposed meeting point and proposed routes to each of the other participants via the communication module 205. The other participants can accept or reject the proposal, or could send a new proposal to the group if desired. Once the participants have responded, then the meeting mapping widget could be used to monitor the progress of the participants towards the meeting point (e.g., at given intervals via the communication module 205 for the other participants and via the position determining module 207 for the mobile device 400), and can update the display accordingly. The user could also utilize the meeting mapping widget 107A to send an updated proposed meeting point, if, for example, the progress of one or more of the participants deviates from the original estimated travel time (e.g., a participant is delayed, a participant is stuck in traffic, etc.).

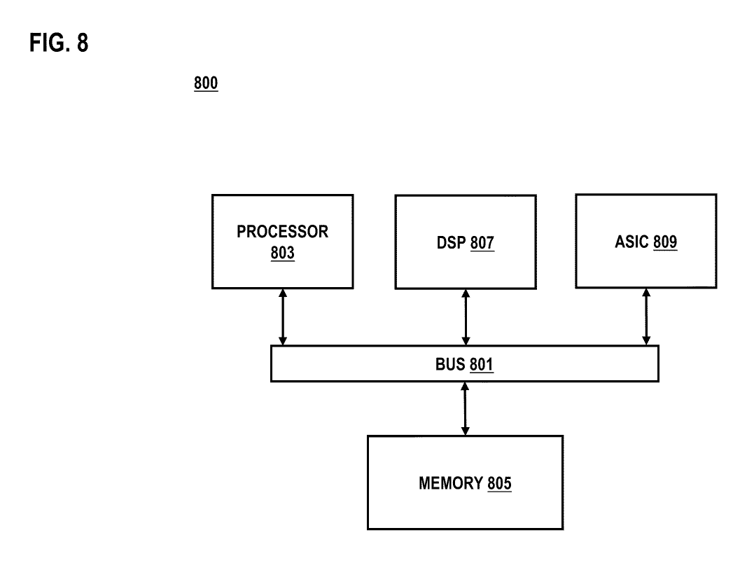

FIG. 5A is a flowchart of a process 500 for providing a meeting point and routes for participants to a proposed meeting using, for example, the mobile device of FIGS. 2 and 4A, according to one embodiment. In one embodiment, the meeting mapping widget 107A performs the process 500 (as well as processes 520 and 540 shown in FIGS. 5B and 5C, respectively) and is implemented in, for instance, a chip set including a processor and a memory as shown FIG. 8.

In step 501, the meeting mapping widget 107A receives a meeting request that is input by the user via the user interface 209, and activates the meeting request, for example, by causing the transmission of the meeting request to other participants using the communication module 205. In step 503, the meeting mapping widget 107A determines the locations of the participants. The meeting mapping widget 107A can also determine the travel methods of the participants. For example, the meeting mapping widget 107A can determine the locations and travel method of the other participants via the communication module 205, for example, by receiving a short message service (SMS) message, IP based messaging service message, or other communication from the other participants in response to the meeting request that includes location information of the other participants and their travel methods to the meeting point. Alternatively, an intermediary service can receive and store location and/or travel methods from the participants and act as a go-between, for example, the service platform 103 and/or the third party server 111. Further alternatively, the location and travel methods may be received from different sources, for example, the location from the other participant's device or location service platform, and the travel methods from a storage service as set by the participant using user preferences (e.g., user A is set to always use a car, user B is set to use a bus for short distances (e.g., within 10 kilometers) and a car for long distances (e.g., greater than 10 kilometers), etc.). Additionally, the meeting mapping widget 107A can determine the location of the user of the mobile device 400 via the position determining module 207, and can cause the display of a request for entry of the travel method to the user on the display screen 401 via the user interface 209.

In step 505, the meeting mapping widget 107A determines the meeting point and proposed routes of the participants to the meeting point, for example, using the calculation module 203. The calculation module 203 can provide a preliminary meeting point, for example, by using an algorithm to calculate a rough center point between the participants that provides the participants with substantially equal estimated travel times based on their locations, available routes, and travel methods. Alternatively, the user can select a preliminary meeting point and then adjust the meeting point as desired. The proposed routes can be calculated by the calculation module 203 based on the proposed meeting point. In step 507, the proposed meeting point and proposed routes can be provided to the other participants, for example, via the communication module 205.

FIG. 5B is a flowchart of a process 520 for providing an adjusted meeting point and routes for participants to a proposed meeting using, for example, the mobile device of FIGS. 2 and 4A, according to one embodiment. The process 520 allows for the user to dynamically adjust the meeting point, for example using a touchscreen display, in order to find a final meeting point that the user desires. The process 520 is any expanded explanation of step 505 depicted in FIG. 5A.

In step 521, an initial meeting point is determined by the meeting mapping widget 107A, for example, by automatic calculation of a rough center point or by user input and selection of an initial meeting point. Also, in step 521, proposed routes to the initial meeting point are determined by the meeting mapping widget 107A using the locations and travel methods of each of the participants. In step 523, the meeting mapping widget 107A provides one or more alternative meeting points (see, e.g., icon 417 in FIG. 4B) around the current meeting point. The alternative meeting points can be provided based on user preferences. In step 525, the meeting mapping widget 107A receives any user input, for example, via the touchscreen display, adjusting the current meeting location, for example, to one of the suggested alternative meeting points or some other location on the map. In step 527, the meeting mapping widget 107A then determines the proposed routes of the participants to the adjusted current meeting point. The process 520 can then loop back to step 523 such that new alternative meeting point(s) around the adjusted meeting point can be provided on the display screen (e.g., within a predetermined radius around the adjusted meeting point), and any additional user input adjustments can be made until a final meeting point is selected by the user and the final proposed routes of the participants are calculated.

FIG. 5C is a flowchart of a process 540 for providing adjustment of a meeting point and routes for participants to a proposed meeting based on progress of participants along routes to the meeting point using, for example, the mobile device of FIGS. 2 and 4A, according to one embodiment. The process 540 is a continuation of the process 500 shown in FIG. 5A.

Once the meeting point and proposed routes are provided to the other participants, and the other participants can either accept or reject the proposal (i.e., decide to join the meeting or decline to join). (As noted above, the other participants could reject the proposal and alternatively send a new proposal.) In step 541, the meeting mapping widget 107A receives acceptance of the meeting point from the other participants via the communication module 205. It is noted that if some of the individuals included in the proposal reject the proposal, then the meeting mapping widget 107A begin process 500 over in order to calculate a new meeting point and proposed routes for the remaining participants, which could significantly alter the meeting point and proposed routes of the remaining participants.

In step 543, the meeting mapping widget 107A and/or another mapping module on the mobile device 400 in conjunction with the position determining module 207 can be used to monitor the movement of the mobile device 400 and provide guidance to the user along the route to the meeting point, for example, using turn-by-turn directions. In step 545, the meeting mapping widget 107A can receive updates (e.g., every minute, every 5 minutes, etc.) regarding the progress of the other participants along their respective routes to the meeting point, and possibly send a notification to the user if one or more of the participants are not progressing as anticipated in their respective estimated travel times. The notification could be, for example, changing color of the icon for that participant, making the icon for that participant blink on the display, etc. In step 547, the meeting mapping widget 107A can allow for the adjustment of the meeting point based on the progress of the participants along their routes, for example, by allowing the user to input an adjusted meeting point and cause the adjusted meeting point and adjusted proposed routes to be sent to the other participants during the meeting mapping session.

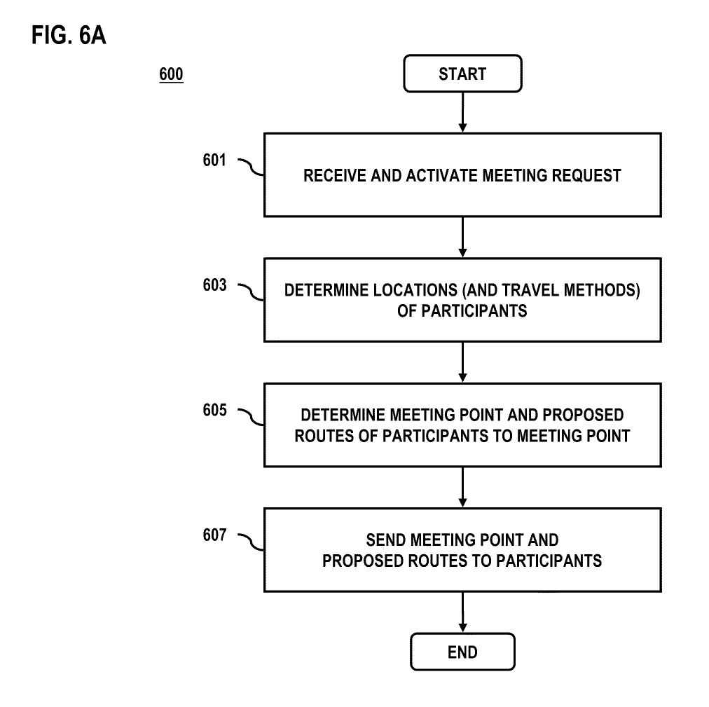

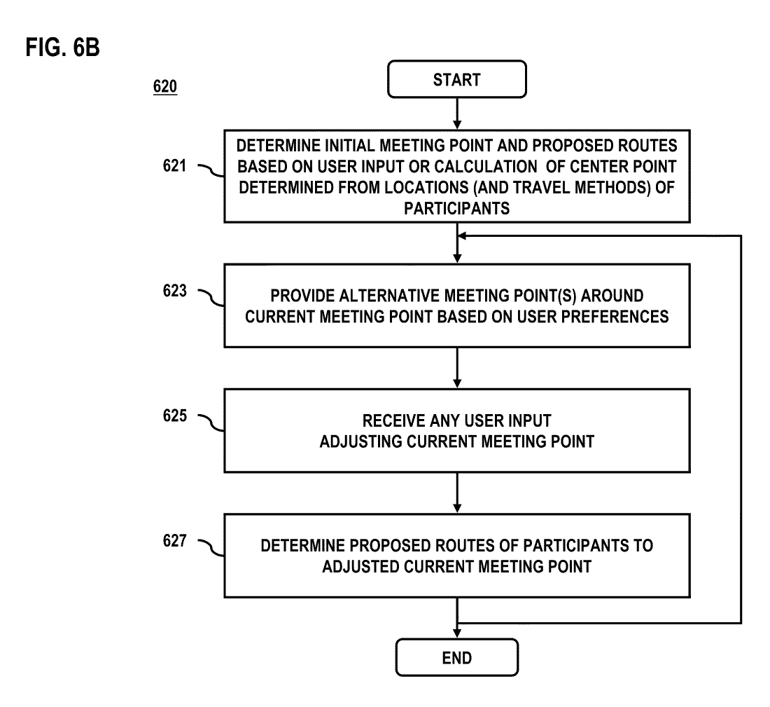

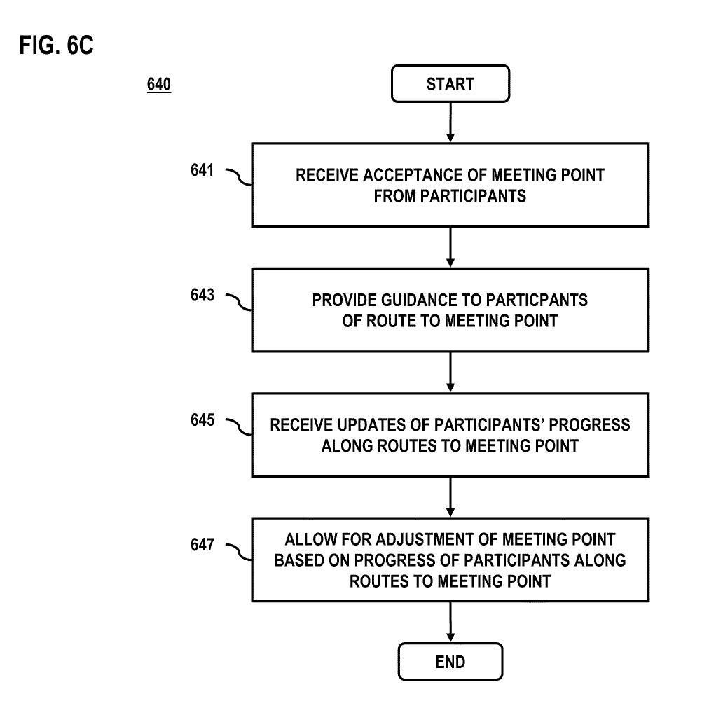

FIG. 6A is a flowchart of a process 600 for providing a meeting point and routes for participants to a proposed meeting using, for example, the service platform 103 of FIG. 3, according to one embodiment. In one embodiment, the management module 301 and/or calculation module 303 performs the process 600 and is implemented in, for instance, a chip set including a processor and a memory as shown FIG. 8.

In step 601, the meeting mapping widget 103A receives via communication module 305 a meeting request that is input by the user via the user interface 209, and activates the meeting request, for example, by causing the transmission of the meeting request to other participants using the communication module 305. In step 603, the meeting mapping widget 103A determines the locations of the participants. The meeting mapping widget 103A can also determine the travel methods of the participants. For example, the meeting mapping widget 103A can determine the locations and travel method of the participants via the communication module 305, for example, by receiving a message, e.g., SMS message, or other communication from the participants in response to the meeting request that includes location information of the participants and their travel methods to the meeting point.

In step 605, the meeting mapping widget 103A determines the meeting point and proposed routes of the participants to the meeting point, for example, using the calculation module 303, and sending such information to the user at mobile device 400 (which may or may not include meeting mapping widget 107A) for input from the user. The calculation module 303 can provide a preliminary meeting point, for example, by using an algorithm to calculate a rough center point between the participants that provides the participants with substantially equal estimated travel times based on their locations, available routes, and travel methods. Alternatively, the meeting mapping widget 103A can provide the user with a map of the participants' locations, and the user can select a preliminary meeting point and then adjust the meeting point as desired. The proposed routes can be calculated by the calculation module 303 based on the proposed meeting point. In step 607, the proposed meeting point and proposed routes can be provided to each of the participants, for example, via the communication module 305.

FIG. 6B is a flowchart of a process 620 for providing an adjusted meeting point and routes for participants to a proposed meeting using, for example, the service platform 103 of FIG. 3, according to one embodiment. The process 620 allows for the user to dynamically adjust the meeting point, for example using a touchscreen display of the mobile device 400, in order to find a final meeting point that the user desires, and sending such selection to the service platform 103. The process 620 is any expanded explanation of step 605 depicted in FIG. 6A.

In step 621, an initial meeting point is determined by the meeting mapping widget 103A, for example, by automatic calculation of a rough center point or by user input and selection of an initial meeting point. Also, in step 621, proposed routes to the initial meeting point are determined by the meeting mapping widget 103A using the locations and travel methods of each of the participants, and such information is provided to the mobile device 400. In step 623, the meeting mapping widget 103A provides one or more alternative meeting points (see, e.g., icon 417 in FIG. 4B) around the current meeting point, and such information is provided to the mobile device 400. The alternative meeting points can be provided based on user preferences. In step 625, the meeting mapping widget 103A receives any user input, for example, via the touchscreen display and via communication modules 205 and 305, adjusting the current meeting location, for example, to one of the suggested alternative meeting points or some other location on the map. In step 627, the meeting mapping widget 103A then determines the proposed routes of the participants to the adjusted current meeting point. The process 620 can then loop back to step 623 such that new alternative meeting point(s) around the adjusted meeting point can be provided on the display screen (e.g., within a predetermined radius around the adjusted meeting point), and any additional user input adjustments can be made until a final meeting point is selected by the user and the final proposed routes of the participants are calculated.

FIG. 6C is a flowchart of a process 640 for providing adjustment of a meeting point and routes for participants to a proposed meeting based on progress of participants along routes to the meeting point using, for example, the service platform 103 of FIG. 3, according to one embodiment. The process 640 is a continuation of the process 600 shown in FIG. 6A.

Once the meeting point and proposed routes are provided to the other participants, and the other participants can either accept or reject the proposal (i.e., decide to join the meeting or decline to join). (As noted above, the other participants could reject the proposal and alternatively send a new proposal.) In step 641, the meeting mapping widget 103A receives acceptance of the meeting point from the other participants via the communication module 305. It is noted that if some of the individuals included in the proposal reject the proposal, then the meeting mapping widget 103A begin process 600 over in order to calculate a new meeting point and proposed routes for the remaining participants, which could significantly alter the meeting point and proposed routes of the remaining participants.

In step 643, the meeting mapping widget 103A and/or a mapping module on the service platform 103, the third party server 111, or the mobile device 400 in conjunction with the position determining module 207 can be used to monitor the movement of the mobile device 400 and provide guidance to the user along the route to the meeting point, for example, using turn-by-turn directions. In step 645, the meeting mapping widget 103A can receive updates (e.g., every minute, every 5 minutes, etc.) regarding the progress of the other participants along their respective routes to the meeting point, and possibly send a notification to the user if one or more of the participants are not progress as anticipated in their respective estimated travel times. In step 647, the meeting mapping widget 103A can allow for the adjustment of the meeting point based on the progress of the participants along their routes, for example, by allowing the user to input an adjusted meeting point and cause the adjusted meeting point and adjusted proposed routes to be sent to the other participants during the meeting mapping session.

The meeting mapping widget can be provided as a feature on a mapping application that helps two or more persons select a meeting point where each has substantially equal distance and/or estimated travel time to the meeting point, so that they can get to together in a convenient manner. The feature aids in the selection of a meeting point such that participants are displayed on the map and the meeting initiator can point to a proposed meeting location on the display screen, such as when using a touchscreen, and the feature can show how much each participant will have to travel to the meeting point and can show the traveling time to that location using routes, rather than direct distances. The application can also show preferences for meeting points, such as landmarks, monuments, cafes, shops, etc., which can be shown using an icon, or other display symbol, around the location that the meeting initiator is pointing on the touchscreen. Also, any stored history of previous meeting points can be taken into account as preferred meeting points and displayed. Users could also define conditions for the meeting point, for example, where a parking lot or metro is nearby, and these conditions can be displayed as hints on the display screen for suitable meeting point.

Thus, the meeting mapping widget can provide for a meeting mapping session such that a meeting point selection by the meeting initiator starts the session, and a meeting request is sent to all proposed participants. The participants can then send their location and if known also their travelling method (e.g., walking, cycling, driving, etc.). The meeting initiator selects the meeting point, such that all participants could reach at substantially the same time using their respective traveling method. The meeting initiator broadcasts the meeting point for all participants, and each participant's mobile device guides the participant to the meeting point. Optionally, the progress of the participants can be monitored and the meeting point adjusted as needed or desired.

The processes described herein for providing a meeting point and routes for participants to a proposed meeting may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

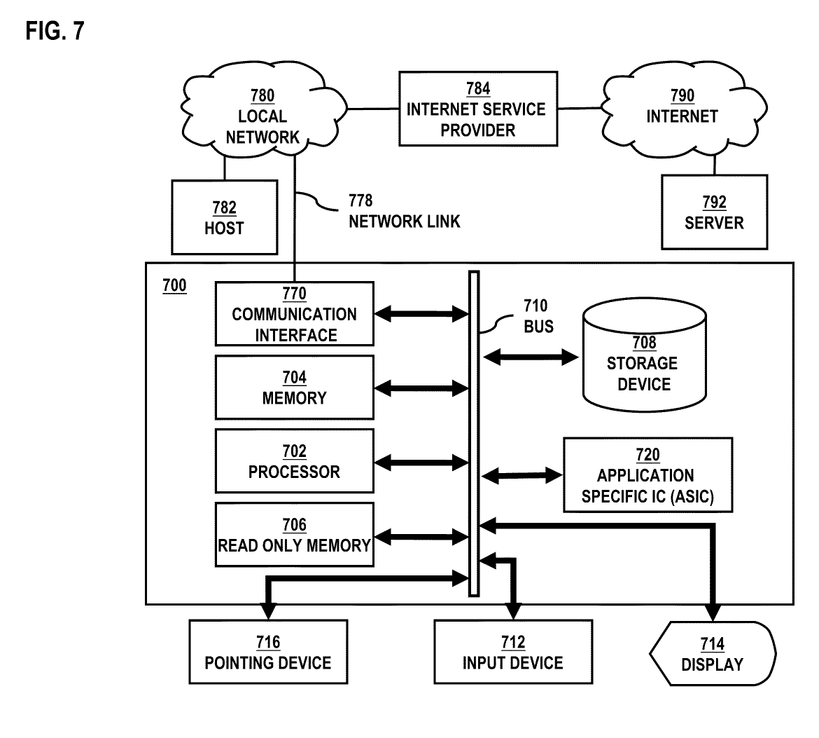

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide a meeting point and routes for participants to a proposed meeting as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing a meeting point and routes for participants to a proposed meeting.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing a meeting point and routes for participants to a proposed meeting. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for providing a meeting point and routes for participants to a proposed meeting. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing a meeting point and routes for participants to a proposed meeting, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing a meeting point and routes for participants to a proposed meeting to the UEs 101A . . . 101N and 109.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to provide a meeting point and routes for participants to a proposed meeting as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of providing a meeting point and routes for participants to a proposed meeting.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide a meeting point and routes for participants to a proposed meeting. The memory 805 also stores the data associated with or generated by the execution of the inventive steps.

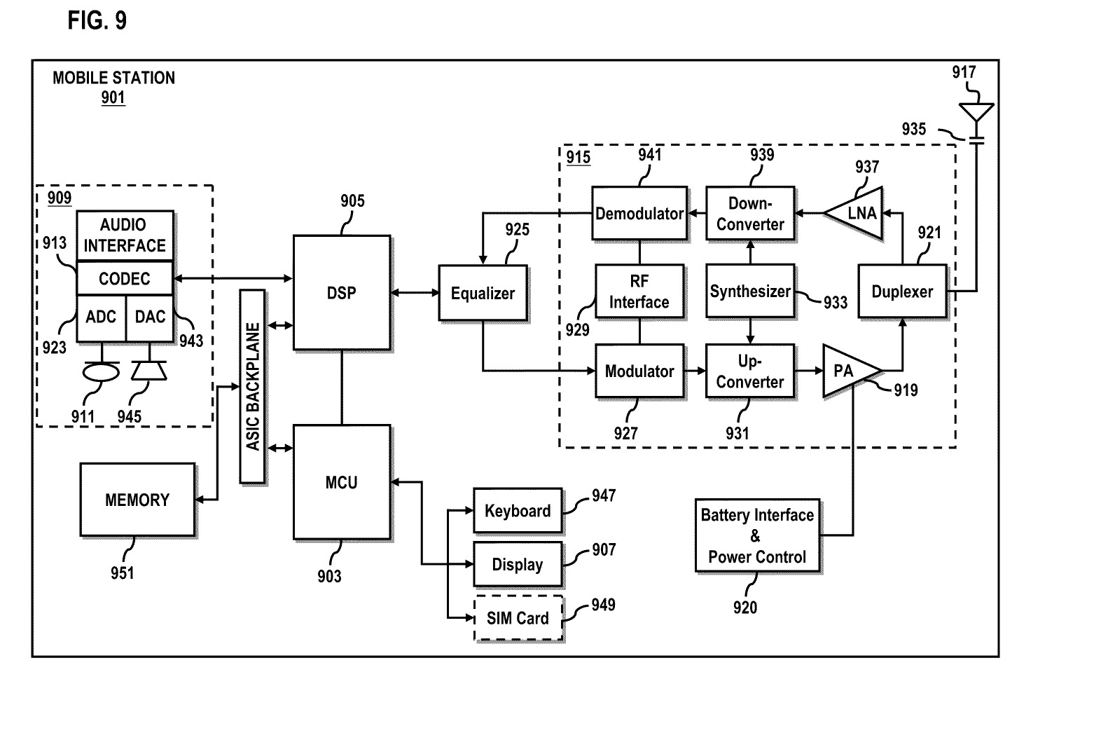

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of providing a meeting point and routes for participants to a proposed meeting. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing a meeting point and routes for participants to a proposed meeting. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide a meeting point and routes for participants to a proposed meeting. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, messages (e.g., SMS messages), and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
causing determination of respective locations of participants to a proposed meeting;
determining, via a mapping application, a meeting point and a proposed route for each of the participants to the meeting point based on the respective locations of the participants, for setting up the proposed meeting; and
electronically providing, to the participants, the meeting point and the proposed routes for display.

2. A method of claim 1, wherein the meeting point is based on the locations of the participants and travel methods of the participants, and wherein the meeting point is determined to provide substantially equal travel time for each of the participants.

3. A method of claim 1, further comprising:
causing display of the meeting point, the proposed routes, and an estimated travel time of each participant to the meeting point.

4. A method of claim 1, further comprising:
causing display of one or more alternative meeting points based on user preferences.

5. A method of claim 1, further comprising:
facilitating adjustment of the meeting point of the participants based on user input; and
determining an adjusted proposed route for each of the participants based on the respective locations of the participants and the adjusted meeting point.

6. A method of claim 5, wherein the user input is input using a touchscreen display of a mobile device.

7. A method of claim 5, further comprising:
causing display of the adjusted meeting point, the adjusted proposed routes, and an estimated travel time of each participant to the adjusted meeting point.

8. A method of claim 1, further comprising:
receiving updated locations of participants traveling to the meeting point; and
allowing adjustment of the meeting point based on progress of the participants traveling to the meeting point.

9. An apparatus comprising:
at least one processor; and
at least one memory including computer program code,
the at least one memory and the computer program code configured to, with the at least one processor, cause the apparatus to perform at least the following:
cause determination of respective locations of participants to a proposed meeting; determine, via a mapping application, a meeting point and a proposed route for each of the participants to the meeting point based on the respective locations of the participants, for setting up the proposed meeting; and
electronically provide, to the participants, the meeting point and the proposed routes for display.

10. An apparatus of claim 9, wherein the meeting point is based on the locations of the participants and travel methods of the participants, and wherein the meeting point is determined to provide substantially equal travel time for each of the participants.

11. An apparatus of claim 9, wherein the apparatus is further caused, at least in part, to:
cause display of the meeting point, the proposed routes, and an estimated travel time of each participant to the meeting point.

12. An apparatus of claim 9, wherein the apparatus is further caused, at least in part, to:
cause display of one or more alternative meeting points based on user preferences.

13. An apparatus of claim 9, wherein the apparatus is further caused, at least in part, to:
facilitate adjustment of the meeting point of the participants based on user input; and
determine an adjusted proposed route for each of the participants based on the respective locations of the participants and the adjusted meeting point.

14. An apparatus of claim 13, wherein the apparatus is a mobile device, and wherein the user input is input using a touchscreen display of the mobile device.

15. An apparatus of claim 13, wherein the apparatus is further caused, at least in part, to:
cause display of the adjusted meeting point, the adjusted proposed routes, and an estimated travel time of each participant to the adjusted meeting point.

16. An apparatus of claim 9, wherein the apparatus is further caused, at least in part, to:
receive updated locations of participants traveling to the meeting point; and
allow adjustment of the meeting point based on progress of the participants traveling to the meeting point.

17. An apparatus of claim 9, wherein the apparatus is a mobile device.

18. An apparatus of claim 9, wherein the apparatus is a server configured to be in communication with one or more mobile devices.

19. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

20. A non-transitory computer-readable storage medium carrying one or more sequences of one or more instructions which, when executed by one or more processors, cause an apparatus to at least perform the following steps:
causing determination of respective locations of participants to a proposed meeting;
determining, via a mapping application, a meeting point and a proposed route for each of the participants to the meeting point based on the respective locations of the participants, for setting up the proposed meeting; and
electronically providing, to the participants, the meeting point and the proposed routes for display.
